(19) United States
(12) Patent Application Publication
(10) Pub. No.: US 2026/0348751 A1
(43) Pub. Date: Nov. 5, 2026

(54) Method and System

(71) Applicant: Putzmeister Engineering GmbH, Aichtal (DE)

(72) Inventor: Uli FREITAG, Moessingen (DE)

(21) Appl. No.: 19/120,332

(22) PCT Filed: Sep. 20, 2023
(86) PCT No.: PCT/EP2023/075934

§ 371 Date: Apr. 11, 2025

(30) Foreign Application Priority Data
Oct. 14, 2022 (DE) 10 2022 210 884.1

(51) Int. Cl. G01F 15/07; G01F 15/06

(52) U.S. Cl. CPC G01F 15/07; G01F 15/068

(57) ABSTRACT

A method predicts a quantity of viscous material which can be conveyed, wherein the quantity can be conveyed by a machine which can be electrically driven. The method has the following steps: a) ascertaining the energy requirement which is required by the electrically driven machine to convey a given unit of quantity of viscous material, b) ascertaining the supply of energy which is available to drive the electrically driven machine, and c) comparing the energy requirement per given unit of quantity with the supply of energy in order to estimate the quantity of viscous material which can be conveyed.

### BACKGROUND AND SUMMARY

The invention relates to a method for predicting a conveyable quantity of viscous material, wherein the conveyable quantity is able to be conveyed by means of an electrically drivable machine. The invention additionally relates to a system for carrying out such a method.

In order to convey viscous material on a construction site, use is conventionally made of machines which have, for their drive, an internal combustion engine and a fuel tank. The internal combustion engine is supplied with fuel from the fuel tank. How much viscous material is still able to be conveyed by the machine depends in this case on a fill level of the fuel tank with fuel. If, instead of the machine having an internal combustion engine, an electrically drivable machine is used to convey viscous material, the fuel tank is dispensed with and thus also the possibility of displaying the fill level.

It is an object of the invention to provide a method for predicting a quantity of viscous material which is able to be conveyed by means of an electrically drivable machine, and a system having such an electrically drivable machine, which enable particularly reliable conveying operation for conveying viscous material.

A method according to the invention is used to predict a conveyable quantity of viscous material. The conveyable quantity is able to be conveyed by means of an electrically drivable machine. The terms “drivable” and “driven” are used synonymously in the present context—unless otherwise specified. The method has a step a). In step a), an energy requirement required by the electrically driven machine to convey a specified unit of quantity of viscous material is ascertained. The method additionally has a step b). In step b), a supply of energy which is available for driving the electrically driven machine is ascertained. Furthermore, the method has a step c). In step c), the energy requirement per specified unit of quantity is compared with the supply of energy in order to estimate the conveyable quantity of viscous material. This estimation can advantageously prevent the present supply of energy from running out during operation of the electrically drivable machine, temporally before a desired quantity of viscous material was required. In the worst case, if the desired quantity of viscous material is not able to be conveyed in full, this may result, without countermeasures, in residual viscous material remaining in the electrically drivable machine. This residual viscous material may then cure, which can lead to impairment or even total failure of the electrically drivable machine. This can be advantageously avoided by means of the method according to the invention. In this way, particularly reliable conveying operation for conveying viscous material is made possible.

In one configuration of the invention, steps a), b) and/or c) are carried out temporally before viscous material is conveyed by means of the electrically drivable machine. In particular, steps a), b) and/or c) are carried out on the basis of a parameterizable digital model of the electrically drivable machine. In this way, it is possible to ensure, already before a conveying operation begins, that the electrically drivable machine is never initially placed in a situation in which the supply of energy could be too small for a desired conveying quantity. Alternatively or in addition, steps a), b) and/or c) are carried out temporally while viscous material is conveyed by means of the electrically drivable machine. In this case, steps a), b) and/or c) can be carried out in continuous repetition while the viscous material is being conveyed. In particular, steps a), b) and/or c) are carried out while the viscous material is being conveyed in such a way that the (still) conveyable quantity of viscous material estimated in step c) is continuously updated. This allows for timely intervention during the conveying operation should there be a risk of premature depletion of the supply of energy. This proves to be advantageous in particular when the energy requirement changes. The energy requirement may change if a geodetic pump height which can be risen above while the viscous material is being conveyed and/or a building material consistency and/or a conveying rate is varied.

In a further configuration of the invention, the electrically drivable machine has an electrical energy store. When ascertaining the supply of energy in step b), a quantity of energy stored in the electrical energy store is taken into account. In this case, the electrical energy store can be charged with electrical energy while consuming an electrical charging power, wherein, when ascertaining the supply of energy in step b), the electrical charging power is taken into account. In this way, the supply of energy can be replenished while the viscous material is being conveyed. Accordingly, a range of the supply of energy can be increased while the viscous material is being conveyed. This increase in the supply of energy can be advantageously taken into account during the estimation in step c).

In a further configuration of the invention, the electrically drivable machine has an electric drive for conveying the viscous material. The electric drive is supplied with electrical energy from an electrical energy store of the electrically drivable machine in order to convey viscous material. The electrically drivable machine can have an electrical connection for connecting its electric drive and -alternatively or in addition—its electrical energy store to an (external) electrical supply network. The electric drive can thus be advantageously supplied with electrical energy while the electrical energy store is being charged.

In a further configuration of the invention, when carrying out step a), an energy requirement/unit of quantity quotient is ascertained. The energy requirement/unit of quantity quotient estimates a quantity of energy required to convey the specified unit of quantity of viscous material. Advantageously, the result is thus a single parameter on the basis of which the estimation in step c) is possible. This parameter can be electronically processed, in particular invoiced, particularly easily.

In a further configuration of the invention, the method additionally comprises a step d). In step d), the electrically drivable machine is operated based on the conveyable quantity of viscous material estimated in step c). In particular, the electrically drivable machine can be automatically switched over between different modes of operation in which the electrically drivable machine consumes different quantities of electrical energy. This enables automatic range optimization of the electrically drivable machine.

In a further configuration of the invention, the electrically drivable machine has an electrical energy store. In this case, when carrying out step a), the energy requirement in relation to the specified unit of quantity is ascertained based on a present electrical power delivered from the electrical energy store. Alternatively or in addition, the energy requirement in relation to the specified unit of quantity is ascertained based on a previous time characteristic of the electrical power delivered from the electrical energy store. This allows for a particularly precise prediction.

In a further configuration of the invention, when carrying out step a), the previous time characteristic of the electrical power delivered from the electrical energy store is weighted higher in relation to the electrical power presently delivered from the electrical energy store the shorter the period since a viscous material conveying operation has been restarted. In this way, it is possible to advantageously compensate for power fluctuations of the electrically drivable machine which differ from an average and which are particularly frequent and pronounced when starting up the electrically drivable machine.

In a further configuration of the invention, a present electrical conveying power is obtained exclusively via an electrical connection of the electrically driven machine so long as the electrical conveying power does not exceed a maximum electrical connection power. So long as the electrical conveying power exceeds the maximum electrical connection power, the present electrical conveying power is obtained via the electrical connection with its maximum electrical connection power and additionally from the electrical energy store. In this way, it can be advantageously ensured that electrical energy is only drawn from the electrical energy store if the electrical connection power drawn from the electrical supply network via the electrical connection is not sufficient to operate the electrically drivable machine at a predetermined operating point. This predetermined operating point may be an operating point at which the electrically drivable machine has its greatest efficiency.

In a further configuration of the invention, the electrical energy store is charged via the electrical connection so long as the electrical conveying power does not exceed the maximum electrical connection power. In this way, the maximum electrical connection power can be used as effectively as possible.

In a further configuration of the invention, based on the comparison in step c) and a present state of charge of the electrical energy store, a still remaining possible conveying quantity of the viscous material is calculated and visualized. The visualization advantageously allows an operator of the electrically drivable machine to make a timely intervention before the available supply of energy is no longer sufficient to process the quantity of viscous material to be conveyed.

In a further configuration of the invention, it is calculated and visualized what proportion of the still remaining possible conveying quantity of the viscous material is based on the electrical power obtained via the electrical connection. In addition, it is calculated and visualized what proportion of the still remaining possible conveying quantity of the viscous material is based on the electrical power obtained from the electrical energy store. The calculation and visualization can be performed based on the comparison in step c). This also advantageously offers the operator possibilities for intervention.

In a further configuration of the invention, a desired conveying quantity is able to be specified. In this case, based on the comparison in step c) and a present state of charge of the electrical energy store, it is calculated whether the desired conveying quantity is able to be conveyed. This allows for a particularly meaningful prediction.

In a further configuration of the invention, the electrically drivable machine has different operating modes for conveying viscous material which differ in terms of their energy requirement per conveyed specified unit of quantity. In this case, in particular when carrying out step e), one of the operating modes is selected based on the desired conveying quantity and based on the present state of charge of the electrical energy store. This selection of one of the operating modes can preferably be performed automatically. This ensures the best possible use of the supply of energy. The term “operating mode” can be understood synonymously to the term “mode of operation”.

In a further configuration of the invention, the method additionally has a step e). In step e), a range value based on the comparison in step c) is output, in particular displayed. In this case, the range value can reflect how large a quantity of energy stored in an electrical energy store of the electrically drivable machine is. Alternatively or in addition, the range value can reflect how large the quantity of viscous material which is (still) able to be conveyed by means of the supply of energy is, in particular in multiples of a holding capacity of a unit truck mixer or of another unit of volume. Alternatively or in addition, the method additionally has a step f). In step f), a desired conveying quantity is defined, in particular is input, and a feasibility attribute is output, in particular is displayed. The feasibility attribute is based on the comparison in step c) and the desired conveying rate. In this case, the feasibility attribute can reflect whether the desired conveying quantity is covered by the conveyable quantity of viscous material. Alternatively or in addition, the feasibility attribute can reflect whether and/or by how much the desired conveying quantity exceeds or falls below the conveyable quantity of viscous material. This allows for a particularly intuitive performance of the method.

The invention additionally relates to a system which has an electrically drivable machine for conveying viscous material. The system additionally comprises an electronic computing unit, in particular control device, which is connected to the electrically drivable machine, in particular for the purpose of transmitting data. In this case, the electronic computing unit is set up to carry out a method according to the invention according to the preceding description. The above-mentioned advantages of the method according to the invention are therefore also transferred to the system according to the invention. Preferably, the electrically drivable machine has an electric drive and an electrical energy store for storing at least part of a supply of energy for supplying energy to the electric drive.

Further advantages and features of the invention emerge from the claims and from the following description of preferred exemplary embodiments of the invention, which are described with reference to the drawings. In this case, the same reference signs refer to identical or similar or functionally identical components.

It is understood that the above-mentioned features and the features that are still to be explained below can be used not only in the respectively specified combination but also in other combinations or by themselves without leaving the scope of the present invention.

### BRIEF DESCRIPTION OF THE DRAWINGS

FIG. 1 is a schematic flowchart of a sequence of an embodiment of a method according to the invention; and

FIG. 2 schematically shows a structure of an embodiment of a system according to the invention.

### DETAILED DESCRIPTION OF THE DRAWINGS

A method is used to predict a conveyable quantity of viscous material D. The conveyable quantity of viscous material D is able to be conveyed by means of an electrically drivable machine 1. The electrically drivable machine 1 is a functional component of a system 10. The electrically drivable machine 1 is used to convey viscous material D. The system 1 additionally has an electronic computing unit 11 which is connected to the electrically drivable machine 1, for example for the purpose of transmitting data. The electronic computing unit 11 may be a control device. The electronic computing unit 11 is set up to carry out the method according to the invention. In the present case, the electrically drivable machine 1 has an electric drive 3 and an electrical energy store 2 for storing at least part of a supply of energy EV for supplying energy to the electric drive 3. The electric drive 3 can be controlled by means of the electronic computing unit 11.

For example, the electrically drivable machine I additionally has a viscous material pump unit which is connected to the electric drive so as to be driven by it. The viscous material pump unit can have conveying cylinders having variable-volume conveying spaces. For a change in the volumes of the conveying spaces, in particular in the opposite direction, the conveying cylinders can each have an adjustable conveying piston. The viscous material pump unit may additionally comprise an S-shaped S tube which is connected at one end in a fluid-conducting manner to a pressure nozzle acting as a pump outlet. The S tube can be arranged in a storage space for storing viscous material, which storage space is able to be filled with viscous material from above. In this case, the S tube can be mounted rotatably within the storage space at one end on the pressure nozzle. The variable-volume conveying spaces can open into the storage space. The S tube can be pivotable in the storage space relative to the conveying spaces in such a way that it is able to be connected alternately to one of the conveying spaces in a fluid-conducting manner. In this way—due to the counterplay of the pivoting of the S tube and a change in the volume of the conveying spaces—viscous material located in the storage space can be alternately sucked in by means of the conveying spaces and via the conveying spaces pumped through the S tube to the outside via the pressure nozzle. In addition, a stirrer may be arranged in the storage space of the viscous material pump unit. While the viscous material is being conveyed, a conveying pressure that is to be provided by means of the viscous material pump unit can change, for example if a conveying quantity is increased and/or a geodetic pump height is changed and/or properties of the conveyed viscous material change. As a result of a changing conveying pressure, the conveying power that is to be provided by means of the viscous material pump unit also changes and thus an energy requirement EB of the electrically drivable machine 1.

The method has a step a). In step a), the energy requirement EB required by the electrically driven machine 1 to convey a specified unit of quantity of viscous material D is ascertained. The method additionally has a step b). In step b), a supply of energy EV which is available for driving the electrically driven machine 1 is ascertained. Moreover, the method comprises a step c). In step c), the energy requirement EB per specified unit of quantity is compared with the supply of energy EV in order to estimate the conveyable quantity of viscous material D. For example, steps a), b) and—alternatively or in addition—c) are carried out temporally before viscous material D is conveyed by means of the electrically drivable machine 1.

The performance of steps a), b) and/or c) temporally before viscous material D is conveyed can be carried out on the basis of a parameterizable digital model of the electrically drivable machine 1. The parameterizable digital model can be based on characteristic values of the electrically drivable machine 1 which were ascertained in the past. The parameterizable digital model can be parameterized in order to be adapted to match local specificities of a site of use, in particular a construction site. As an alternative to performing steps a), b) and/or c) before the conveying of viscous material begins, steps a), b) and/or c) can be carried out while the viscous material is being conveyed. Steps a), b) and—alternatively or in addition—c) can thus be carried out, for example, temporally while viscous material D is conveyed by means of the electrically drivable machine 1. In this case, steps a), b) and/or c) can be carried out in continuous repetition while the viscous material is being conveyed. In particular, steps a), b) and/or c) are carried out while the viscous material is being conveyed in such a way that the conveyable quantity of viscous material D estimated in step e) is continuously updated. In this respect, a statement about the quantity of viscous material D which is still able to be conveyed can be updated continuously.

As already mentioned, the electrically drivable machine 1 has an electrical energy store 2 in the present case. In this case, when ascertaining the supply of energy EV in step b), a quantity of energy ES stored in the electrical energy store 2 is taken into account. In this case, the electrical energy store 2 can be charged with electrical energy while consuming an electrical charging power PL. When ascertaining the supply of energy EV in step b), this electrical charging power PL can be taken into account. It is thus possible to take into account how much electrical energy is drawn from the electrical energy store 2 and how much electrical energy is supplied to the electrical energy store 2 by means of the electrical charging power PL.

As also already mentioned, the electrically drivable machine 1 has an electric drive 3 for conveying the viscous material D in the present case. In this case, the electric drive 3 is supplied with electrical energy from the electrical energy store 2 of the electrically drivable machine 1 in order to convey viscous material D. For example, the electrically drivable machine 1 has an electrical connection 4 for connecting its electric drive 3 to an electrical supply network V. Alternatively or in addition, the electrical connection 4 can be designed to connect the electrical energy store 2 to the electrical supply network V. The electrical supply network V can be an external, for example public, electrical supply network V. However, it is also conceivable for the electrical supply network V to be a local electrical supply network V present at the site of use. The electrical connection 4 can be set up to be connected to a supply network V of different current strengths.

For example, when carrying out step a), an energy requirement/unit of quantity quotient is ascertained. The energy requirement/unit of quantity quotient estimates a quantity of energy required to convey the specified unit of quantity of viscous material D.

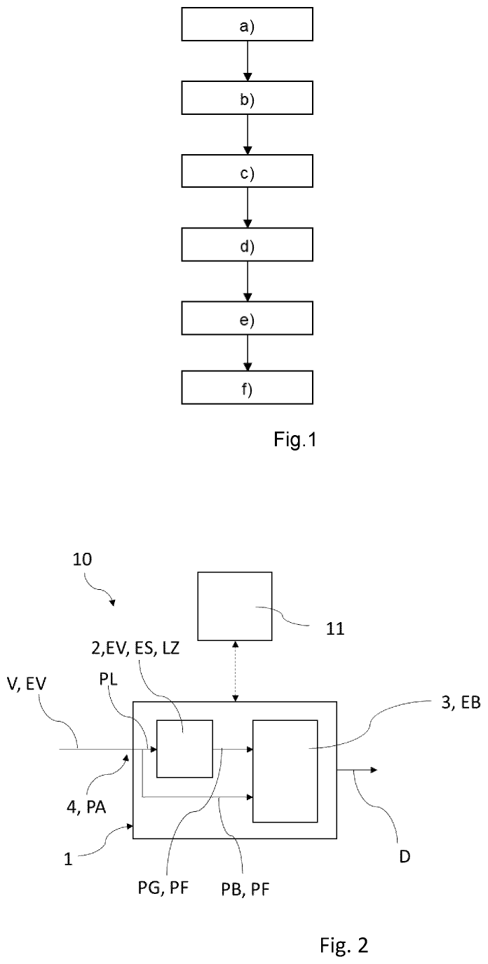

In the embodiment according to FIG. 1, the method additionally has a step d). In step d), the electrically drivable machine 1 is operated based on the conveyable quantity of viscous material D estimated in step e).

For example, when carrying out step a), the energy requirement EB in relation to the specified unit of quantity is ascertained, namely based on a present electrical power PG delivered from the electrical energy store 2. Alternatively or in addition, the energy requirement EB is ascertained based on a previous time characteristic of the electrical power PG delivered from the electrical energy store 2. In this case, when carrying out step a), the previous time characteristic of the electrical power PG delivered from the electrical energy store 2 can be weighted higher in relation to the electrical power PG presently delivered from the electrical energy store 2 the shorter the period since a viscous material conveying operation has been restarted. Particularly at the beginning of the viscous material conveying operation—that is to say, for example, when the electric machine 1 is restarted—the electrical power PG delivered from the electrical energy store 2 may differ greatly from an average electrical power PG delivered from the electrical energy store 2. This can be at least partly compensated for by the weighting mentioned above. The electronic computing unit 11 can have an algorithm for machine learning, which can be learnt automatically from past operating data of the system 10, in order to gradually refine the accuracy of the prediction by means of the method according to the invention.

For example, a present electrical conveying power PF is obtained exclusively via the electrical connection 4 of the electrically driven machine 1 so long as the electrical conveying power PF does not exceed a maximum electrical connection power PA. In this case, the present electrical conveying power PF is obtained via the electrical connection 4 with its maximum electrical connection power PA and additionally from the electrical energy store 2 so long as the electrical conveying power PF exceeds the maximum electrical connection power PA. If the maximum electrical connection power PA is thus not sufficient on its own to provide the electrical conveying power PF required to convey the viscous material, part of the electrical conveying power PF can additionally be obtained from the electrical energy store 2. Conversely, it is possible to dispense with drawing energy from the electrical energy store 2 if the maximum electrical connection power PA is sufficient to provide the electrical conveying power PF. So long as the electrical conveying power PF does not exceed the maximum electrical connection power, the electrical energy store 2 can be charged via the electrical connection 4.

For example, a still remaining possible conveying quantity of the viscous material D is calculated based on the comparison in step c) and a present state of charge LZ of the electrical energy store 2. In addition, the still remaining possible conveying quantity of the viscous material D can be visualized. For example, it is calculated and visualized what proportion of the still remaining possible conveying quantity of the viscous material is based on the electrical power PB obtained via the electrical connection 4 and what proportion of the still remaining possible conveying quantity of the viscous material D is based on the electrical power PG obtained from the electrical energy store 2.

For example, a desired conveying quantity is able to be specified. Based on the comparison in step c) and a present state of charge LZ of the electrical energy store 2, it is calculated whether the desired conveying quantity is able to be conveyed. The result of this calculation can likewise be visualized.

By virtue of the visualization described above, it can be made clear to an operator of the system 10 what it brings them when they use a connection to the power distributor present on a construction site. It is also possible to deliberately leave a certain residual quantity of electrical energy in the electrical energy store 2 so that this residual quantity can be used for a construction site which is to be subsequently worked on.

The electrically drivable machine I can have different operating modes for conveying viscous material D. These operating modes differ, for example, in terms of their energy requirement per conveyed specified unit of quantity. In this case—in particular when carrying out step c)—one of the operating modes can be selected based on the desired conveying quantity and based on the present state of charge LZ of the electrical energy store 2. This selection of one of the operating modes can be performed automatically. Therefore, the electrically drivable machine 1 can be automatically put in an energy-saving mode, if it results that the supply of energy EV during normal operation of the electrically drivable machine I is not sufficient for the specified unit of quantity of viscous material D. In an energy-optimized operating mode, a piston speed of the viscous material pump unit can be reduced. In addition, auxiliary loads such as the stirrer and, where necessary, present coolers or filters can be selectively taken out of operation. This adjustment can be made in stages such that not only is the energy-optimized operating mode available but a plurality of operating modes which can gradually reduce the energy consumption of the electrically drivable machine 1.

The method according to FIG. 1 additionally has a step e). In step e), a range value is output, for example displayed. The range value is based on the comparison in step c). In this case, the range value can reflect how large a quantity of energy ES stored in the electrical energy store 2 of the electrically drivable machine 1 is. Alternatively or in addition, the range value can reflect how large the quantity of viscous material D which is still able to be conveyed by means of the supply of energy EV is. For example, the quantity of viscous material D which is still able to be conveyed can be specified in multiples of a holding capacity of a unit truck mixer or of another unit of volume. The quantity which is still able to be conveyed can be specified in cubic meters per hour or cubic yards per hour. The “quantity which is still able to be conveyed” can be referred to as the “residual conveying quantity”.

The method additionally comprises a step f) according to FIG. 1. In step f), a desired conveying quantity is defined. For example, the desired conveying quantity can be input. In step f), a feasibility attribute, which is based on the comparison in step c) and the desired conveying quantity, is additionally output, in particular displayed. In this case, the feasibility attribute can reflect whether the desired conveying quantity is covered by the conveyable quantity of viscous material. Alternatively or in addition, the feasibility attribute can reflect whether and/or by how much the desired conveying quantity exceeds or falls below the conveyable quantity of viscous material D. The feasibility attribute can, for example, reflect whether the supply of energy EV is sufficient, barely sufficient or insufficient to convey the desired conveying quantity.

Based on the above-mentioned parameterizable digital model of the electrically drivable machine 1, a construction site planning system can be realized. This construction site planning system can be a computer program product which is able to be executed on a conventional computer. The computer program product can be used to simulate how many electrically drivable machines are required to convey viscous material on a certain construction site. The simulated construction site can likewise be present as a parameterizable digital model of the construction site planning system. In this case, the one or more parameterizable digital models can be parameterized depending on specific local conditions of a simulated construction site and/or the electrically drivable machine 1. For example, a specific local condition may be a locally present electrical supply network V and its specification. The electrical supply network V may, for example, deliver electrical current with a current strength of 16 A, 32 A, 63 A or 125 A, depending on the specification. It is also possible for there to be no electrical supply network V at all at the simulated construction site such that the electrically drivable machine 1 can exclusively be supplied with electrical energy from the electrical energy store 2.

1.-16. (canceled)

17. A method for predicting a conveyable quantity of viscous material, wherein the conveyable quantity is able to be conveyed via an electrically drivable machine, the method comprising the steps of:
a) ascertaining an energy requirement required by the electrically driven machine to convey a specified unit of quantity of viscous material;
b) ascertaining a supply of energy which is available for driving the electrically driven machine; and
c) comparing the energy requirement per specified unit of quantity with the supply of energy in order to estimate the conveyable quantity of viscous material.

18. The method as claimed in claim 17, wherein (i) steps a), b) and/or c), on the basis of a parameterizable digital model of the electrically drivable machine, are carried out temporally before viscous material is conveyed via the electrically drivable machine, and/or
(ii) steps a), b) and/or c), in continuous repetition, are carried out temporally while viscous material is conveyed via the electrically drivable machine, such that the conveyable quantity of viscous material estimated in step c) is continuously updated.

19. The method as claimed in claim 17, wherein
the electrically drivable machine has an electrical energy store, and
when ascertaining the supply of energy in step b), a quantity of energy stored in the electrical energy store is taken into account.

20. The method as claimed in claim 19, wherein
the electrical energy store is charged with electrical energy while consuming an electrical charging power and, when ascertaining the supply of energy in step b), the electrical charging power is taken into account.

21. The method as claimed in claim 17, wherein
the electrically drivable machine has an electric drive for conveying the viscous material, and
the electric drive is supplied with electrical energy from an electrical energy store of the electrically drivable machine in order to convey viscous material.

22. The method as claimed in claim 21, wherein
the electrically drivable machine has an electrical connection for connecting its electric drive and/or its electrical energy store to an external electrical supply network.

23. The method as claimed in claim 17, wherein
when carrying out step a), an energy requirement/unit of quantity quotient which estimates a quantity of energy required to convey the specified unit of quantity of viscous material is ascertained.

24. The method as claimed in claim 17, further comprising the step of:
d) operating the electrically drivable machine based on the conveyable quantity of viscous material estimated in step c).

25. The method as claimed in claim 17, wherein
the electrically drivable machine has an electrical energy store, and
when carrying out step a), the energy requirement in relation to the specified unit of quantity is ascertained based on:
(i) a present electrical power delivered from the electrical energy store, and/or
(ii) a previous time characteristic of the electrical power delivered from the electrical energy store.

26. The method as claimed in claim 25, wherein
when carrying out step a), the previous time characteristic of the electrical power delivered from the electrical energy store is weighted higher in relation to the electrical power presently delivered from the electrical energy store the shorter the period since a viscous material conveying operation has been restarted.

27. The method as claimed in claim 25, wherein
a present electrical conveying power is obtained exclusively via an electrical connection of the electrically driven machine so long as the electrical conveying power does not exceed a maximum electrical connection power, and
the present electrical conveying power is obtained via the electrical connection with its maximum electrical connection power and additionally from the electrical energy store so long as the electrical conveying power exceeds the maximum electrical connection power.

28. The method as claimed in claim 27, wherein
so long as the electrical conveying power does not exceed the maximum electrical connection power, the electrical energy store is charged via the electrical connection.

29. The method as claimed in claim 25, wherein
based on the comparison in step c) and a present state of charge of the electrical energy store, a still remaining possible conveying quantity of the viscous material is calculated and visually indicated.

30. The method as claimed in claim 25, further comprising:
calculating and visually indicating, based on the comparison in step c), what proportion of the still remaining possible conveying quantity of the viscous material is based on the electrical power obtained via the electrical connection and what proportion of the still remaining possible conveying quantity of the viscous material is based on the electrical power obtained from the electrical energy store.

31. The method as claimed in claim 25, wherein
a desired conveying quantity is able to be specified, wherein, based on the comparison in step c) and a present state of charge of the electrical energy store, it is calculated whether the desired conveying quantity is able to be conveyed.

32. The method as claimed in claim 31, wherein
the electrically drivable machine has different operating modes for conveying viscous material which differ in terms of their energy requirement per conveyed specified unit of quantity, and
when carrying out step e), one of the operating modes is selected based on the desired conveying quantity and based on the present state of charge of the electrical energy store.

33. The method as claimed in claim 17, further comprising at least one of the following steps e) and f):
e) outputting a range value based on the comparison in step c), wherein the range value in indicates:
(i) how large is a quantity of energy stored in an electrical energy store of the electrically drivable machine, and/or
(ii) how large is the quantity of viscous material which is able to be conveyed by the supply of energy, in multiples of a holding capacity of a unit truck mixer or of another unit of volume;
f) defining a desired conveying quantity and outputting a feasibility attribute based on the comparison in step c) and the desired conveying quantity, wherein the feasibility attribute indicates:
(i) whether the desired conveying quantity is covered by the conveyable quantity of viscous material, and/or
(ii) whether and/or by how much the desired conveying quantity exceeds or falls below the conveyable quantity of viscous material.

34. A system, comprising:
an electrically drivable machine for conveying viscous material;
an electronic computing unit connected to the electrically drivable machine for transmitting data,
wherein the electronic computing unit is operatively configured to:
a) ascertain an energy requirement required by the electrically driven machine to convey a specified unit of quantity of viscous material;
b) ascertain a supply of energy which is available for driving the electrically driven machine; and
c) compare the energy requirement per specified unit of quantity with the supply of energy in order to estimate the conveyable quantity of viscous material.

35. The system as claimed in claim 34, wherein
the electrically drivable machine has an electric drive and an electrical energy store for storing at least part of a supply of energy for supplying energy to the electric drive.
